(19) United States
(12) Patent Application Publication
(10) Pub. No.: US 2018/0306339 A1
(43) Pub. Date: Oct. 25, 2018

(54) Antiknock valve with both sides resisting shock wave and valve body thereof

(71) Applicant: WUXI FUCARE INDUSTRIAL CO., LTD, Wuxi, Jiangsu (CN)

(72) Inventor: Jun Xie, Wuxi, Jiangsu (CN)

(21) Appl. No.: 15/770,754

(22) PCT Filed: Nov. 16, 2015
(86) PCT No.: PCT/CN2015/094650

§ 371 Date: Apr. 25, 2018

(30) Foreign Application Priority Data
Oct. 30, 2015 (CN) 201510733938.9

(51) Int. Cl. F16K 17/36; E04B 1/98; F16K 1/44

(52) U.S. Cl. CPC F16K 17/36; F16K 1/443; E04B 1/98

(57) ABSTRACT

An antiknock valve with both sides resisting a shock wave, and a valve body thereof. The antiknock valve includes a valve core (200) and two valve bodies (A3, A4). The valve body (A3/A4) includes a frame body (101/102), wherein two intersected supporters(2a, 2b/3a) are provided in the frame body (101/102) in a symmetrical manner, the supporters (2a, 2b/3a, 3b) intersect on a ridge-shaped column (2d/3d) and openings(2c1/3c2) are provided at intervals along the direction of the ridge-shaped column (2d/3d). The valve cores (200) are located above the openings (2c1/3c2) and the two valve bodies (A3, A4) are engaged and fixed; and one end of the valve core (200) is rotatably connected on the ridge-shaped column (2d/3d). Since the antiknock valve reduces the weight of the valve core (200), the antiknock capacity is improved, a closing speed is increases, and the antiknock valve is safer.

### CROSS REFERENCE OF RELATED APPLICATION

This is a U.S. National Stage under 35 U.S.0 371 of the International Application PCT/CN2015/094650, filed Nov. 16, 2015, which claims priority under 35 U.S.C. 119(a-d) to CN 201510733938.9, filed Oct. 30, 2015.

### BACKGROUND OF THE PRESENT INVENTION

### Field of Invention

The present invention relates to the field of ventilation equipment of fresh air entrance and exhaust ventilation outlet in buildings, and more particularly to the ventilation valves of fresh air inlets and exhaust outlets of buildings with potential explosion shock wave hazards, in particular to an antiknock valve with both sides resisting shock wave and a valve body thereof.

### Background of the Invention

There are two stages in the explosion shock wave that will cause serious damage. In the first stage, the center point of the explosion will release shock wave with pressure up to tens of thousands of atmospheric pressure on the first settlement. The shock wave will form a spherical surface at high speed and have serious impact damages. With the increase of distance of the shock wave from the center point of explosion, the pressure of the shock wave will rapidly decay. In the second stage, the air in the explosion center will generate negative pressure due to the decompression of air, resulting in a strong negative pressure wave. When the negative pressure wave is generated, the pressure in the building is greater than the outdoor pressure, and the ventilation valve will be being pushed out by pressure. A certain level of negative pressure waves can also cause damage to the facilities in the building, especially when the ventilation valve is close to the center point of the explosion.

As shown in FIG. 1 and FIG. 2, in the conventional art, antiknock valve with both sides resisting shock wave mainly adopts one to three valve cores B2 with a cross-section of a square, round or other shapes, and ventilation channel is closed and opened by the front and rear parallel movements. In normal ventilation, the valve core B2 is in the middle equilibrium position to provide ventilation function. When an explosion impact occurs, the shock wave pressure applied to the valve core B2 closes the valve core and blocks the shock wave from entering the protected side of the building or the ventilation system. When the shock wave changes from positive pressure to negative pressure, the valve core moves to the other side, reducing the ventilation passage until the valve core closes the ventilation passage. However, the existing antiknock valve adopts a large valve core design, therefor its opening B3 has a large length which results in low structural strength, so its ability to resist high-level shock wave is limited, wherein the current highest anti-explosion capability is 12 bar high reflection pressure, lasting about 70 ms. The weight of a single valve core is large, and the initial speed is slow under a certain impact wave impulse, resulting in a long closing time, and thus a larger part of the shock wave energy passes through the valve body, which poses a certain risk to the human beings and equipment at protected side.

### SUMMARY OF THE PRESENT INVENTION

An object of the present invention is to provide a valve body capable of explosion resistance.

Another object of the invention is to provide a valve assembly capable of enhancing explosion-resistance and better response speed.

Another object of the present invention is to provide an antiknock valve with both sides resisting shock wave which can greatly reduce the weight of the valve core, can increase the blast-resistant strength, and can also increase the closing speed of the valve core to reduce the shock wave energy that passes through the passage of valve and eventually increases the safety performance of valve significantly.

Another object of the present invention is to provide a method to increase the response speed of the antiknock valve.

A bionic tortoise shell valve body comprises: a frame body;

wherein two supporters which are intersected are symmetrically settled in the frame body; openings are provided with intervals on the two supporters.

The two supporters could be either intersected directly or through their geometrical extension.

The frame body and the two supporters are an integrated body.

Reinforce ribs are provided on a back face of the two supporters which are intersected. The intersection of the two supporters is spine and the two supporters are rib array. The reinforce ribs could be extension of spine itself between the two supporters, or individual parts welded to spine, or extended ribs under the rib array which are also called the two supporters.

The openings on the two intersected supporters are symmetrically provided.

The steps are provided on the up side face of the frame body.

The limit slots are provided on the internal side walls of the frame body.

A bionic tortoise shell valve body assembly, comprises: two valve bodies;

wherein each of the two valve bodies comprises a frame body; two intersected supporters with symmetrical openings by interval provided in the frame body; steps are provided on the up side face of the frame body; the two valve bodies are provided one above another; the steps of the two valves on the up side face of the frame body are engaged; and the openings of the intersected supporters are symmetrically provided; reinforcer ribs are provided on an internal side of the two intersected supporting parts. The reinforcers can be formed by extending the spinal towards an internal side of the two supporters which are intersected; or by fixing on the spine on an internal side of the two supporters which are intersected by welding or other manners; or by extending the framework of the supporters towards an internal side of the supporters which are intersected. Intersected portion of the two supporters is a spine; the supporters on two sides of the spine are a framework.

In the technical solution mentioned above, a limit slot is provided on the internal side wall of the framework.

A bionic tortoise-shell small-valve-core-array antiknock valve, comprises: the valve cores and two valve bodies; wherein each of the two valve bodies comprises a frame body; two intersected supporters with symmetrical openings by interval provided in the frame body; The intersection of the supporters is the spine;

wherein the valve cores are provided above the openings of the supporter;

the two valve bodies are matched and fixed; wherein front faces of the supporter of the two valve bodies are opposite and connected with the up side faces of the body frames;

a firstne end of the valve cores which are capable of rotating, is connected and mounted with the spine portion, the windward faces of the valve cores sit in a middle portion of the valve cavity by springs fixed to valve frame bodies.

The valve core is flake shaped. The valve core could also be in a square, elliptical or other cross-sectional shapes, and the specific shape is not limited, as long as the through-slot can be turned off when the shock wave comes. However, the flake shaped valve is lighter and has a lower response time.

In the technical solutions mentioned above, the limit slots are provided on an internal side walls of the frame body; the limit slots are configured to limit a second end of the valve cores when the valve cores rotates. When shock wave comes, the limit structure is capable of effectively avoiding the left-right shake of the valve core caused by the shock wave; in such a manner that the valve core is capable of turning off the openings better, so as to enhance the turning-off efficiency of the ventilation channel. The limit structure can be a limit groove or a limit block.

In the technical solutions mentioned above, reinforcers are provided on a back face of the supporters. Intersected portion of the two supporters is a spine; the supporters on two sides of the spine are a framework. The reinforcers can be formed by extending the spinal towards an internal side of the two supporters which are intersected; or by fixing on the spine on an internal side of the two supporters which are intersected by welding or other manners; or by extending the framework of the supporters towards an internal side of the supporters which are intersected. The width and thickness of the ribs can be adjusted according to the requirements of the anti-explosion level.

In the technical solutions mentioned above, stuck slots are provided on the spines, when the two valve bodies are matched, the stuck slots of the two valve bodies are cooperated to form a groove cavity; a first end of a connector is inserted in the groove cavity; and a second end of the connector is connected with an end of the valve core. During the process of turning on and turning off the ventilation channel, the valve core rotates, so the groove cavity is capable of limit the connector, so as to ensure that the first end of the connector is always in the groove cavity.

In the technical solutions mentioned above, steps are provided on an up side face of the frame body. When the two valves are matched and fixed, the steps on the up side face of the two frame bodies are engaged. The steps on the one hand facilitates the matching and positioning of the two valve bodies, on the other hand enhances the installation speed, and in addition enhances the cooperation stability of the two valve bodies.

In the technical solutions mentioned above, the two valves which are provided one above the other are symmetrically provided, which is capable of effectively achieving double sided ventilation and antiknock of the ventilation and antiknock valve.

A method for improving a response speed of a valve core of an antiknock valve, comprises: providing two valve bodies which are oppositely provided and fixedly connected and a plurality of valve cores;

wherein the valve bodies comprises frame bodies; two supporters which are symmetrically provided in the frame bodies; openings are provide with intervals on the supporters; the valve cores are provided on an up portion of the openings on a front face of the two supporters; the valve cores are provided in a middle portion of the valve cavity by springs on a base; rotatably connecting a first end of the valve core with an intersected portion of the supporters; wherein the valve core is capable of rotating around a connecting portion of an intersected portion. The manner of turning on and off the ventilation channel between the conventional valve core and the valve body by a forward and backward parallel movement in the conventional arts is converted to a way of turning on and off the ventilation channel between the valve core and the valve body through a rotatable connection.

### Beneficial Effects

In the conventional arts, anti-shock wave ventilation valve adopts a large valve core design, the length of the opening in the valve body for the ventilation channel is long, the weight of a single valve core is large, the structural strength is low, and the initial speed of the valve core obtained under the impulse of the shock wave is low.

1) Two intersected supports are provided in the frame body, and openings, which are used for ventilation in the conventional arts, are provided on the support body with a short length, so that the weight and volume of a single valve core are greatly reduced, and the weight of the valve core is reduced which results in faster initial speed obtained under the impact of the shock wave, and the time for closing the ventilation passage is shortened, which greatly improves the response speed of the valve core when the shock wave arrives. In the conventional arts, under a reflected pressure of 10 bar by shock wave, the valve core's response speed is 1 ms, and the valve core's response speed is 0.5 ms in this invention.

2) For anti-knock valves of the same specification, the weight of a single valve core of the present invention is only one-tenth of the weight of a single valve core of the prior arts.

3) In present invention the parts subjected to impact is a triangular supporter formed by the two intersected supporters and the frame together, which greatly enhances the anti-knocking performance of the anti-knocking main body. The double-side anti-shock valve of the same type in the conventional art is only capable of resisting multiple shocks of the shock wave with a peak reflection pressure of 12 Bar, while the present invention can withstand multiple shocks of a shock wave with a peak emission pressure of 60 Bar, so the anti-explosion level is greatly enhanced.

### BRIEF DESCRIPTION OF THE DRAWINGS

Further description of the present invention is illustrated combining with the accompany drawings.

FIG. 1 is a first cooperation sketch view of a valve body and a valve core in the conventional art.

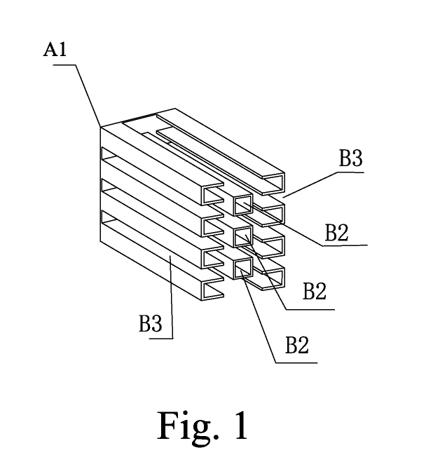

FIG. 2 is a second cooperation sketch view of a frame the valve body and the valve core in the conventional art.

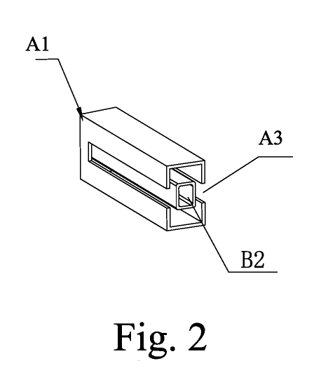

FIG. 3 is a front stereo image of a frame body 100 according to a first preferred embodiment of the present invention.

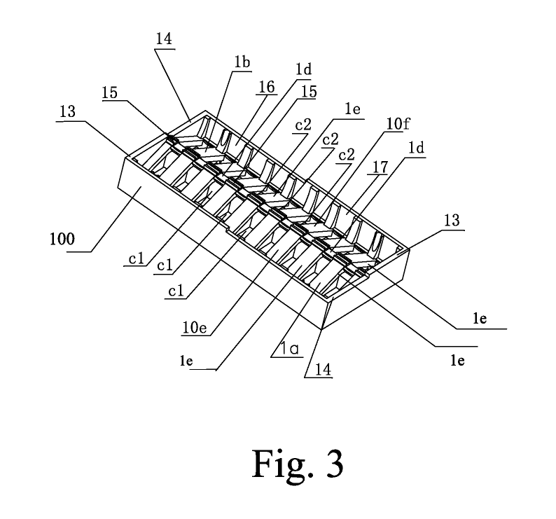

FIG. 4 is a back stereo image of the frame body 100 according to the first preferred embodiment of the present invention.

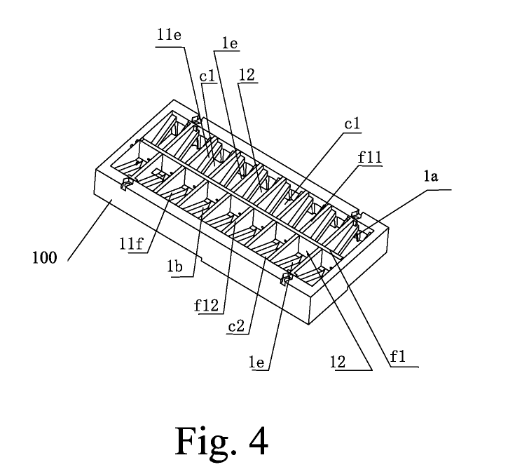

FIG. 5 is a sectional view of the frame body 100 according to the preferred embodiment of the present invention.

FIG. 6 is a top view of the frame body 100 from a front face according to the first preferred embodiment of the present invention.

FIG. 7 is a bottom view of the frame body 100 from a back face according to the first preferred embodiment of the present invention.

FIG. 8 is a front-stereo image of a first valve body A3 according to a second preferred embodiment of the present invention.

FIG. 9 is a back-stereo image of the first valve body A3 according to a second preferred embodiment of the present invention.

FIG. 10 is a sectional view of the first valve body A3 according to a second preferred embodiment of the present invention.

FIG. 11 is a front-stereo image of a first valve body A4 according to a second preferred embodiment of the present invention.

FIG. 12 is a back-stereo image of the first valve body A4 according to a second preferred embodiment of the present invention.

FIG. 13 is a sectional view of the first valve body A4 according to a second preferred embodiment of the present invention.

FIG. 14 is a stereo image of an antiknock valve according to the second preferred embodiment of the present invention.

FIG. 15 is a first sectional view antiknock valve according to the second preferred embodiment of the present invention.

FIG. 16 is a second sectional view antiknock valve according to the second preferred embodiment of the present invention.

FIG. 17 is a schematic view of a spring 301, a spring 302, a spring 303 and a spring 304 according to the second preferred embodiment of the present invention.

### REFERENCE NUMBERS IN THE FIGS.

A1-valve body; B2-valve core; B3-opening; A3-first valve body; A4-second valve body; D-valve cavity; 100-first frame body; 101-second frame body; 102-third frame body; 201-first valve core; 202-second valve core; 20a-first windward face; 20b-second windward face; 20c-third windward face; 20d-fourth windward face; 301-first spring; 302-second spring; 303-third spring; 304-fourth spring; 5-fixture; 7-connector; 9-groove cavity;

1a-first supporter; c1-opening; 10e-first-supporter front face; 11-first-supporter back face;

1b-second supporter; c2-second opening; 10f-second-supporter front face; 11f-second-supporter back face;

1d-first spine; 1e-first framework; f1-first reinforcer; f11-second reinforcer; f12-third reinforcer;

2a-third supporter; 2c1-third opening; 2b-fourth supporter; 2c2-fourth opening;

2d-second spine; 2e-second framework; f2a-fourth reinforcer; f2b-fifth reinforcer; f2c-sixth reinforcer;

3a-fifth supporter; 3c1-fifth opening; 3b-sixth supporter; 3c2-sixth opening;

3d-third spine; 3e-third framework; f3a-seventh reinforcer; f3b-eighth reinforcer; f3c-ninth reinforcer;

10a-third-supporter front face; 10b-fourth-supporter front face; 10c-fifth-supporter front face; 10d-sixth-supporter front face;

11a-third-supporter back face; 11b-fourth supporter back face; 11c-fifth supporter back face; 11d-sixth supporter back face;

12-two intersected supporter internal side; 12a-two intersected supporter internal side; 12b-two intersected supporter internal side;

13-first up side face; 13a-second up side face; 13b-third up side face;

14-first step; 15-first stuck slot; 16-first internal side wall; 17-first limit slot;

14a-second step; 15a-second stuck slot; 16a-second internal side wall; 17a-second limit slot;

14b-third step; 15b-third stuck slot; 16b-third internal side wall; 17b-third limit slot;

81-first pin; 82-second pin; 83-third pin; 84-fourth pin

### DETAILED DESCRIPTION OF THE PREFERRED EMBODIMENT

In order to further illustrate the present invention and beneficial effects thereof, the present invention is described combining with the accompanying drawings. One skilled in the art will understand that the embodiment of the present invention as shown in the drawings and described above is exemplary only and not intended to be limiting.

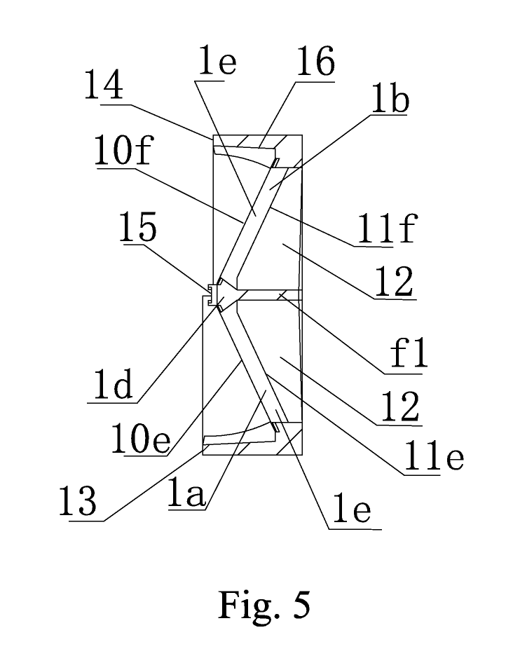

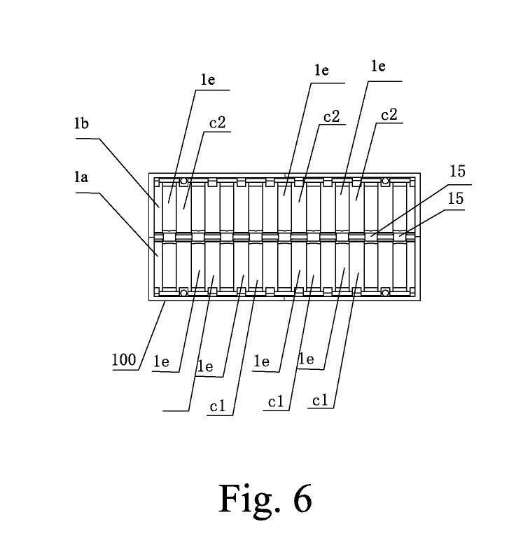

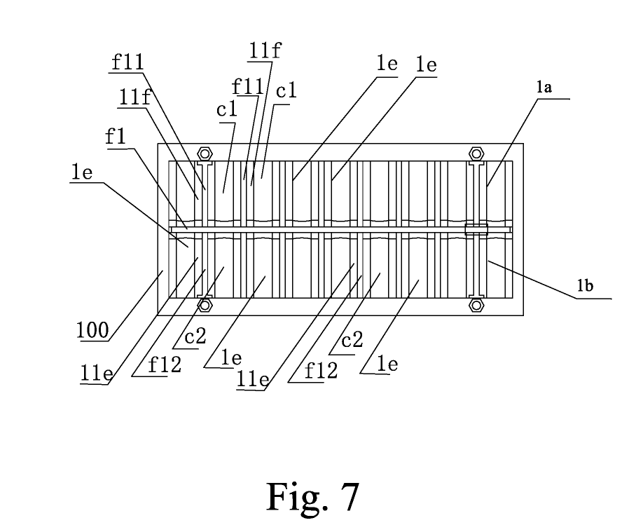

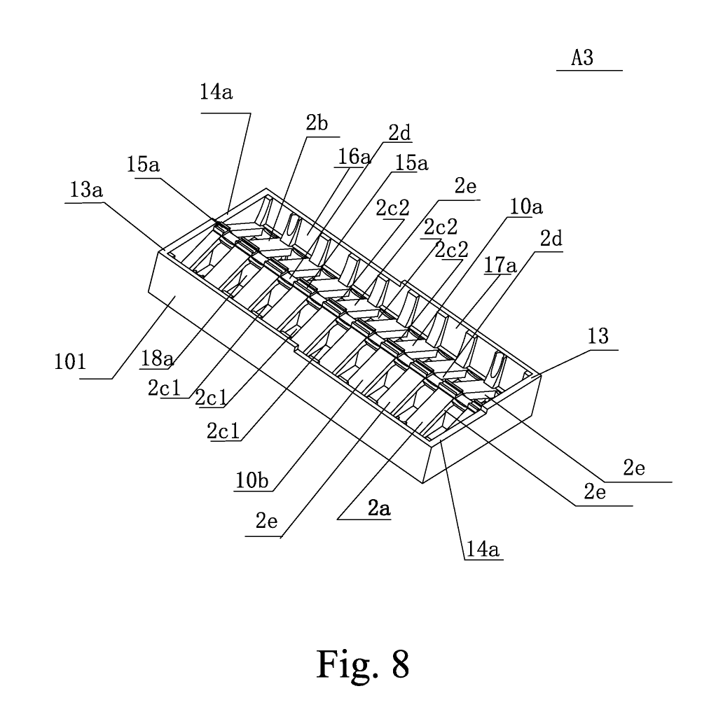

### Embodiment 1 (See FIGS. 5-8 of the Drawings)

A bionic tortoise shell valve body comprises: a first frame body 100 with a quadrilateral framework shape, a first supporter 1a and a second supporter 1b which are casted into an integrated body. The first supporter la and the second supporter 1b which are intersected and symmetrically provided in the first frame body 100. Openings c1 are provided with intervals on the first supporter 1a along a direction of a first spine 1d. Second openings c2 are provided with intervals on the second supporter 1b along a direction of the first spine 1d. The openings c1 on the first supporter 1a and the second openings c2 on the second supporter 1b are symmetrically provided. An intersected portion of the first supporter 1a and the second supporter 1b is a first spine 1d. The first supporter 1a and the second supporter 1b on two sides of the first spine 1d form a first framework 1e.

The first spine 1d extends towards two intersected supporter internal side 12 to form a first reinforce f1. A second reinforce f11 is provided on a first-supporter back face 11 of the first framework 1e. A third reinforce f12 is provided on a second-supporter back face 11f of the first framework le.

The second reinforce f11 is formed by extending the first supporter 1a towards the two intersected supporter internal side 12. The third reinforcer f12 is formed by extending the second supporter 1b towards the two intersected supporter internal side 12.

First steps 14 are provided on opposite angles of a first up side face of the first frame body 100. A first limit slot 17 is provided on a first internal side wall 16 of the first frame body 100. First stuck slots 15 are provided with intervals on the first spine 1d.

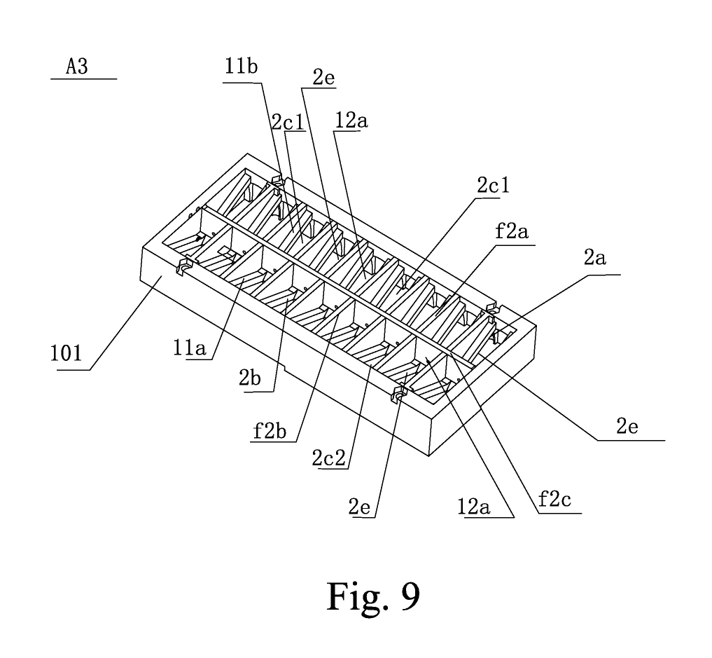

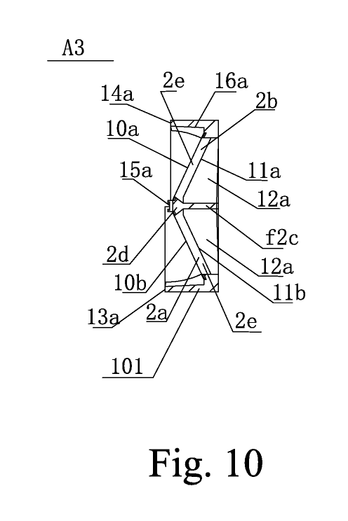

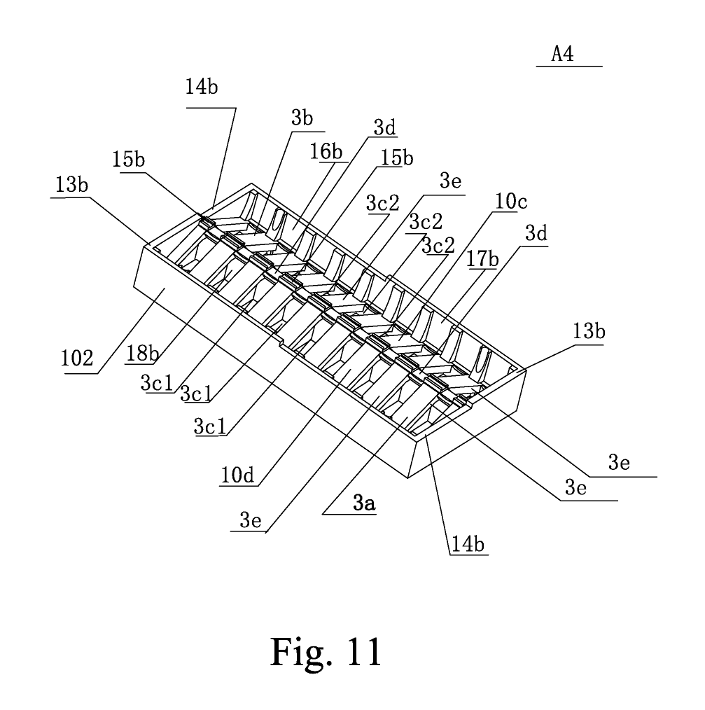

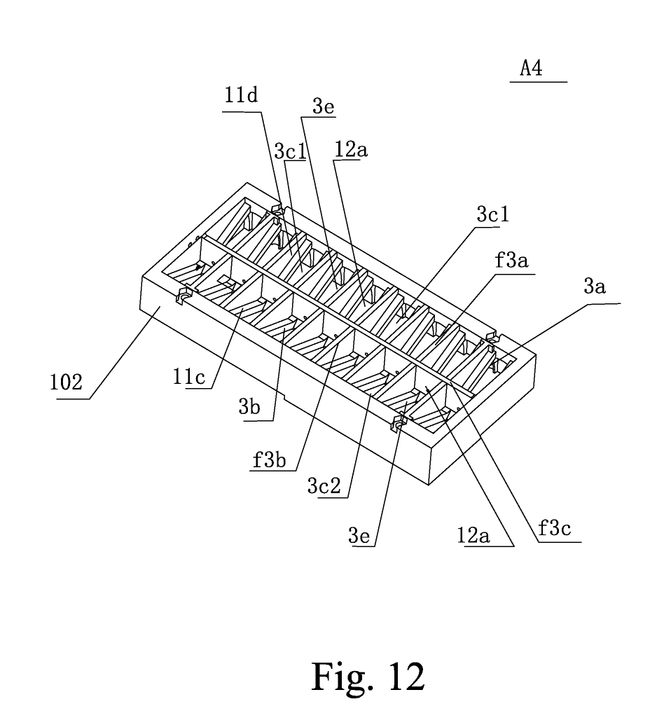

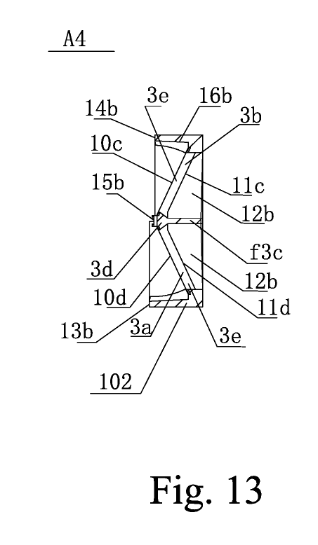

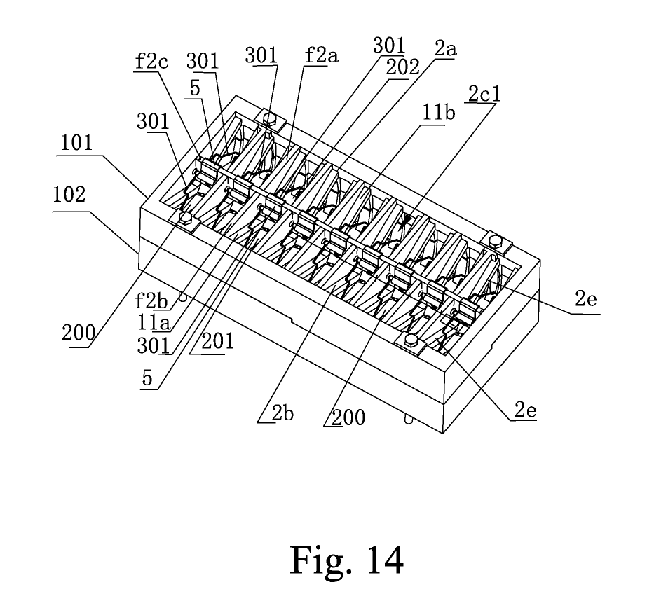

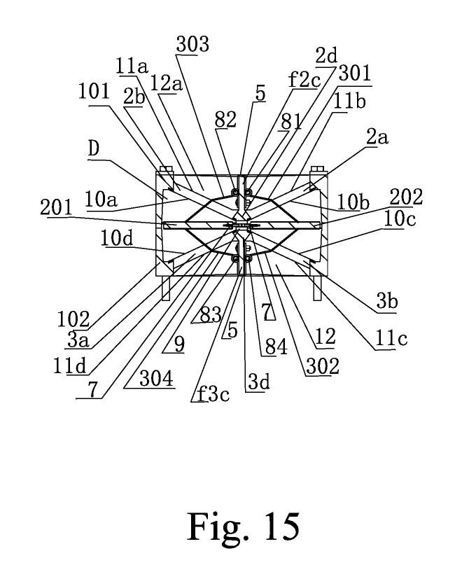

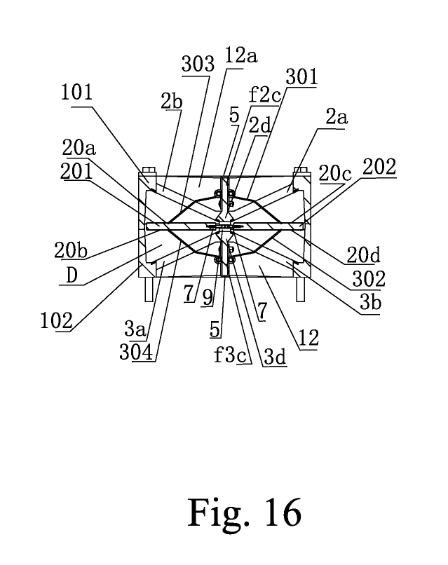

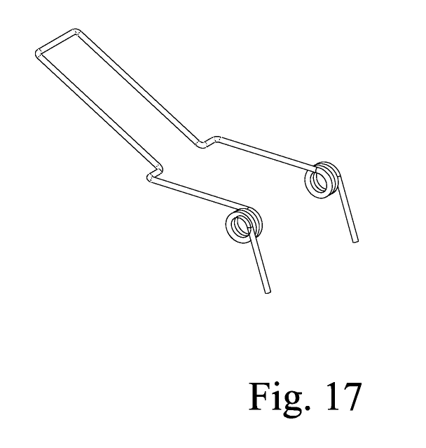

### Embodiment 2: See FIGS. 9-17 of the Drawings

A bionic tortoise-shell small valve core array antiknock valve comprises: a plurality of valve cores 200, a first valve body A3 and a second valve body A4.

The first valve body A3 comprises a second frame body 101 which is in a quadrilateral shape; a third supporter 2a and a fourth supporter 2b which are intersected are symmetrically provided in the second frame body 101; the second frame body 101 is integrated with the third supporter 2a and the fourth supporter 2b; an intersected portion of the third supporter 2a and the fourth supporter 2b is a second spine 2d; the third supporter 2a and the fourth supporter 2b on two sides of the second spine 2d is a second framework 2e; openings 2c1 are provided with intervals on the third supporter 2a along a direction of the second spine 2d; openings 2c2 are provided with intervals on the fourth supporter 2b along the second spine 2d; the openings 2c1 on the third supporter 2a and the openings 2c2 on the fourth supporter 2b are symmetrically provided; second steps 14a are provided on a second up side face 13a of the second frame body 101; a second limit slot 17a is provided on a second internal side wall 16a of the second frame body 101; second stuck slots 15a are provided with intervals on the second spine 2d; the second spine 2d is extended towards two intersected supporter internal side 12a to form a sixth reinforcer f2c; the second framework 2e is extended towards a third-supporter back face 11a of the third supporter 2a to form a fourth reinforce f2a; the second framework 2e is extended towards a fourth supporter back face 11b of the fourth supporter 2b to form a fifth reinforcer.

The second valve body A4 comprises a third frame body 102 which is in a quadrilateral shape; a fifth supporter 3a and a sixth supporter 3b which are intersected and are symmetrically provided in the third frame body 102 which is in a quadrilateral shape; the third frame body 102 is integrated with the fifth supporter 3a and the sixth supporter 3b; an intersected portion of the fifth supporter 3a and the sixth supporter 3b is a third spine 3d; the fifth supporter 3a and the sixth supporter 3b on two sides of the third spine 3d is a third framework 3e; openings 2c1 are provided with intervals on the fifth supporter 3a along a direction of the third spine 3d; openings 3c2 are provided with intervals on the sixth supporter 3b along the first spine 1d; the openings 3c1 on the fifth supporter 3a and the openings 2c2 on the sixth supporter 3b are symmetrically provided; third steps 14b are provided on a third up side face 14b of the third frame body 102; a third limit slot 17b is provided on a third internal side wall 16b of the third frame body 102; third stuck slots 15b are provided with intervals on the third spine 3d; the third spine 3d is extended towards two intersected supporter internal side 12b to form a seventh reinforcer f3c; the second framework 3e is extended towards a third-supporter back face 11d of the fifth supporter 3a to form a fifth reinforcer f3a; the third framework 3e is extended towards a fifth supporter back face 11d of the fifth supporter 3a to form a sixth reinforcer f3b.

The first valve body A3 and the second valve body A4 are coupled and fixed by a screw; wherein two second steps 14a are provided on two opposite angles of a first up side face 15a of the second frame body 101; two third steps 14b are provided on two opposite angles of a second up side face 15b of a third frame body 102; the two second steps 14a on the first up side face 15a of the second frame body 101 are engaged with the two third steps 14b on the second up side face 15b of a third frame body 102; the second stuck slots 15a are matched with the third stuck slots 15b to form a groove cavity 9.

A first end of the first valve core 201 is fixed with a first end of a connector 7; a second end of the connector 7 is rotatably mounted in the groove cavity 9; the first valve core 201 is provided between the fourth opening 2c2 and the fifth opening 3c1.

A first end of the second valve core 202 is connected with the first end of the connector 7; a second end of the connector 7 is rotatably mounted in the groove cavity 9; the second valve core 202 is provided between the third opening 2c1 and the sixth opening 3c2.

A first pin 81 passes through a first end of a first spring 301 to match with a fixture 5, the fixture 5 is fixed with the sixth reinforce f2c; both ends of the first pin 81 are fixedly connected with the fourth reinforce f2a; the first spring 301 is capable of rotating around the first pin 81; a second end of the first spring 301 is pressed on a third windward face 20c of the second valve core 202.

A fourth pin 84 passes through a first end of a second spring 302 to match with the fixture 5, the fixture 5 is fixed with a ninth reinforcer f3c; both ends of the fourth pin 84 are fixedly connected with an eighth reinforcer f3b; the second spring 302 is capable of rotating around the fourth pin 84; a second end of the second spring 302 is pressed on a fourth windward face 20d of the second valve core 202.

Under normal ventilation conditions, the second valve core 202 is in a middle portion of a valve cavity D under cooperation of the first spring 301 and the second spring 302, so as to ensure that a ventilation channel is turned on.

A second pin 82 passes through a first end of a third spring 303 to match with the fixture 5, the fixture 5 is fixed with the sixth reinforcer f2c; both ends of the second pin 82 are fixedly connected with the fifth reinforcer f2b; the third spring 303 is capable of rotating around the second pin 82; a second end of the third spring 303 is pressed on the first windward face 20a of the first valve core 201.

A third pin 83 passes through a first end of a third spring 304 to match with the fixture 5, the fixture 5 is fixed with the ninth reinforcer f3c; both ends of the third pin 83 are fixedly connected with a seventh reinforcer f3a; the fourth spring 304 is capable of rotating around the third pin 83; a second end of the fourth spring 304 is pressed on a second windward face 20b of the first valve core 201.

Under normal ventilation conditions, the first valve core 201 is in a middle portion of the valve cavity D under cooperation of the third spring 303 and the fourth spring 304, so as to ensure that the ventilation channel is turned on.

When the bionic tortoise-shell small valve core array antiknock valve meets positive-pressure shock wave or negative-pressure shock wave;

if the first valve core 201 rotates anticlockwise to contact the third framework 3e, i.e., the first valve core 201 contacts a fifth-supporter front face 10d; the second valve core 202 rotates clockwise to contact the third framework 3e, i.e., the second valve core 202 contacts the sixth-supporter front face 10c; the ventilation channel is turned off, the first valve core 201 and the second valve core 202 are in flakes;

if the first valve core 201 rotates clockwise to contact the second framework 2e, i.e., the first valve core 201 contacts a fourth-supporter front face 10a; the second valve core 202 rotates anticlockwise to contact the third framework 2e, i.e., the second valve core 202 contacts the third-supporter front face 10b; the ventilation channel is turned off.

During rotating process of the first valve core 201 and the second valve core 202, the first end of the first valve core 201 and the first end of the second valve core 202 rotate respectively in a second limit slot 17a and a third limit slot 17b.

By rotatably connecting the first valve core 201 and the second valve core 202 on the spine, a turning-off speed of the first valve core 201 and the second valve core improves from 1 ms to 0.5 ms under a reflected pressure of 10 bar by shock wave; and a weight of valve core in this invention is only one-tenth of an weight of conventional valve core.

1-16. (canceled)

17. A bionic tortoise shell valve body group for antiknocking comprising: a first valve body and a second valve body;
wherein the first valve body comprises a first frame body and the second valve body comprises a second frame body; two supporters which are intersected are symmetrically provided in the first frame body and the second frame body; openings are provided with intervals on the two supporters; the openings on the two supporters which are intersected are symmetrically provided; wherein a first portion where the two supporters are intersected is a spine; and a second portion of the two supporters on two sides of the spine is a framework;
the frame body and the two supporters which are intersected are an integrated body;
the two valves are provided one above another, front faces of the two supporters are opposite each other and connected with an up side face of the first frame body and an up side face of the second frame body; the first valve body and the second valve body are matched and fixed with each other.

18. The bionic tortoise shell valve body group for antiknocking, as recited in claim 17, wherein reinforcers are provided on back faces of the two supporters which are intersected;
wherein the reinforcers comprise: a first portion formed by extending the spine towards an internal side of the two supporters which are intersected; and a second portion formed by extending the framework of the supporters towards an internal side of the two supporters which are intersected.

19. The bionic tortoise shell valve body group for antiknocking, as recited in claim 17, wherein first group steps are provided on an up side face of the first frame body and second group steps are provided on an up side face of the second frame body; wherein the first group steps on an up side face of the first valve body are engaged with the second group steps on an up side face of the second valve body.

20. The bionic tortoise shell valve body group for antiknocking, as recited in claim 19, wherein a first limit structure is provided on an internal side wall of the first frame body; a second limit structure is provided on an internal side wall of the second frame body.

21. A bionic tortoise shell small valve core array antiknock valve, comprising: valve cores and two valve bodies; wherein each of the two valve bodies comprises a frame body; two supporters which are intersected are symmetrically provided in each of the frame body; openings are provided with intervals on the supporters; an intersected portion of the supporters is a spine;
the frame body and the two supporters which are intersected are an integrated body;
wherein the valve cores are provided above the openings of the supporter;
the two valve bodies are matched and fixed; wherein front faces of the supporters of the two valve bodies are opposite and connected with the up side face of the frame bodies;
a first end of the valve core is rotatably connected and mounted with the spine, a windward face of the valve core is provided in a middle portion of the valve cavity by springs fixed on frame bodies.

22. The bionic tortoise shell small valve core array antiknock valve, as recited in claim 21, wherein the valve core is flake shaped.

23. The bionic tortoise shell small valve core array antiknock valve, as recited in claim 22, a limit structure is provided on an internal side wall of the frame body; the limit groove is configured to limit a second end of the valve core when the valve core rotates.

24. The bionic tortoise shell small valve core array antiknock valve, as recited in claim 21, wherein reinforcers are provided on a back face of the two supporters.

25. The bionic tortoise shell small valve core array antiknock valve, as recited in claim 24, wherein stuck slots are provided on the spines, the stuck slots of the two valve bodies are cooperated to form a groove cavity; a first end of a connector is stuck in the groove cavity; and a second end of the connector is connected with an end of the valve core.

26. The bionic tortoise shell small valve core array antiknock valve, as recited in claim 25, wherein the openings on the two valve bodies are symmetrically provided.

27. The bionic tortoise shell small valve core array antiknock valve, as recited in claim 24, wherein steps are provided on the frame bodies; when the two valve bodies are matched and fixed, steps on an up side face of the two frame bodies are engaged.

28. The bionic tortoise shell small valve core array antiknock valve, as recited in claim 25, wherein steps are provided on the frame bodies; when the two valve bodies are matched and fixed, steps on an up side face of the two frame bodies are engaged; the openings on the two valve bodies are symmetrically provided.

29. A method for enhancing a response rate of a valve core of an antiknock valve, comprising: providing two valve bodies which are oppositely provided and fixedly connected and a plurality of valve cores;
wherein the valve bodies comprises frame bodies; two supporters which are symmetrically provided in the frame bodies; the frame body and the two supporters which are intersected are an integrated body; openings are provide with intervals on the supporters; the two valve bodies are matched and fixed, wherein front faces of the supporters of the two valve bodies are opposite and connected with the up side face of the frame bodies; the valve cores are provide on an up portion of the openings on a front face of the two supporters; the valve cores are provided in a middle portion of the valve cavity by springs on a base; rotatably connecting a first end of the valve core with an intersected portion of the supporters; wherein the valve core is capable of rotating around a connecting portion of an intersected portion.
